(19) United States
(12) Patent Application Publication
(10) Pub. No.: US 2021/0348803 A1
(43) Pub. Date: Nov. 11, 2021

(54) PIPE FLUID HEAT EXCHANGE FLAT PIPE AND DEVICE FOR HEATING PIPE FLUID

(71) Applicant: Yeon Chul CHUNG, Yongin-Si (KR)

(72) Inventor: Yeon Chul CHUNG, Yongin-Si (KR)

(21) Appl. No.: 17/277,671

(22) PCT Filed: Sep. 10, 2019
(86) PCT No.: PCT/KR2019/011674

§ 371 Date: Mar. 18, 2021

(30) Foreign Application Priority Data
Sep. 19, 2018 (KR) 10 2018 0112476

(51) Int. Cl. F24H 1/10; F28F 1/42; F24D 3/02; F24D 3/08; H05B 1/02

(52) U.S. Cl. CPC F24H 1/102; F28F 1/42; H05B 2203/02; F24D 3/087; H05B 1/0283; F24D 3/02

(57) ABSTRACT

According to the present invention, disclosed is a pipe fluid heat exchange flat pipe, which has a cross section having a width direction size that is larger than the size in the height direction thereof, extends in a longitudinal direction, and has a plurality of flat parts and curved parts that are alternately formed, wherein a plurality of lower guides protruding from the inner lower surface of the flat pipe toward the upper side thereof and upper guides protruding from the inner upper surface of the flat pipe toward the lower side thereof are alternately provided in the width direction of the flat pipe, and either the lower guide or the upper guide has an overlapping part overlapped with the other from either of the adjacent lower guide or upper guide in the height direction of the flat pipe.

### FIELD OF INVENTION

The present invention relates to a flat pipe for heat exchange of a fluid in a pipe, which is disposed adjacent to a heating element in a heating and hot water supply apparatus and heats a fluid while the same passes therethrough so as to conduct a heat exchange process.

### BACKGROUND OF INVENTION

In general, an electric boiler is configured to heat water, as a heating medium, with electricity, which in turn enables the heated water to heat a room while circulating through a pipeline. Therefore, it has a simpler and more hygienic structure than a boiler using oil as fuel, and relatively reduced risk of fire due to overheating. Further, since electricity called clean energy is used, the electric boiler does not emit exhaust gas during operation, thereby encountering no concern about polluting an air environment while having an advantage of high efficiency.

However, in the case of the electric boiler, a circulating medium is water having a high specific heat, causing a problem of taking a considerable time to raise the temperature to a predetermined level after supplying power.

Further, when the water is heated to 100° C. or higher, air bubbles are generated, causing noise and vibration, whereby a temperature of the hot water is hard to control in order to be maintained at 100° C. or lower.

Further, since a large amount of water must be stored and then heated and used, a hot water tank is required and an apparatus is enlarged to correspond to a capacity of the hot water tank.

(Patent Document 1) Korean Utility Model Laid-Open Publication No. 20-2016-0004430 (Laid-open on Dec. 26, 2016)

### SUMMARY OF INVENTION

### Technical Problem to Be Solved

The flat pipe for heat exchange of a fluid in a pipe (“in-pipe fluid”) and the in-pipe fluid heating device according to the present invention may suppress occurrence of air bubbles and noise in the flat pipe, may control a temperature of hot water appropriately for heating and/or hot water supply, and may supply the hot water to a desired place in a short time.

### Technical Solution

The present invention provides a flat pipe for heat exchange of a fluid in a pipe (“in-pipe fluid”). The flat pipe for heat exchange of in-pipe fluid, which has a cross section with a width direction size larger than a height direction size, extends in a longitudinal direction and includes a plurality of flat parts and curved parts formed alternately, may include: a plurality of lower guides protruding from an inner lower surface of the flat pipe toward an upper side thereof, and a plurality of upper guides protruding from an inner upper surface of the flat pipe toward a lower side thereof, which are alternately provided in the width direction of the flat pipe; and an overlapping portion present in either the lower guide or the upper guide, at which the lower guide or the upper guide is overlapped with either of the adjacent upper guide or lower upper guide in the height direction of the flat pipe.

According to the present invention, at least one of the lower guide and the upper guide may have the overlapping portion formed in a range of 25% or more and 87.5% or less of the height direction size of the flat pipe.

According to the present invention, at least one of the lower guide and the upper guide may be provided with a wide direction guide protruding in the width direction of the flat pipe.

According to the present invention, the flat pipe may be divided into an inflow unit for inflow of a fluid and an outflow unit for outflow of the fluid in a longitudinal direction and the number of the lower guides and upper guides provided in the inflow unit may be more than the number of the lower guides and upper guides provided in the outflow unit.

The in-pipe fluid heating device according to the present invention may include: the flat pipe for heat exchange of in-pipe fluid; and a heating element disposed between the flat parts of the flat pipe in order to heat the fluid flowing inside the flat pipe.

According to the present invention, an uneven part may be formed on outer upper and lower surfaces of the flat pipe in the width direction of the flat pipe and may extend in the longitudinal direction of the flat pipe. On the other hand, another uneven part having a shape complementary to that of the above uneven part may be formed on upper and lower surfaces of the heating element. Further, an alternative uneven part having a shape complementary to the uneven part may be formed on a side where the heating element is in contact with the curved part of the flat pipe.

According to the present invention, the heating device may further include a case that surrounds the flat pipe and the heating element and imparts elastic force to maintain contact between the flat pipe and the heating element.

According to the present invention, the case may include: a slit extending and opening in the longitudinal direction of the flat pipe on the case; fixing members protruding on both sides of the width of the slit and facing each other; and a connector that connects the fixing members to each other and applies contractile force to reduce a spacing therebetween.

According to the present invention, a heat insulating material may be filled between the case and the flat pipe in order to prevent transfer of heat generated by the heating element to the outside.

The heating and hot water supply apparatus according to the present invention may include: an in-pipe fluid heating device (“heating device”); a heating pipe in which a fluid heated in the heating device, that is, heating water, circulates; a heating unit connected to the heating pipe and installed in a space to be heated in order to heat the space; a pump connected to the heating pipe to circulate the heating water in the heating pipe while passing through the heating device and the heating unit; a hot water supply pipe that receives water from a tap water supply and delivers the same to a user; and a heat exchanger connected to the hot water supply pipe to exchange heat between tap water in the hot water supply pipe, that is, the hot water to be supplied (“hot water”) and the heating water in the heating pipe to increase a temperature of the hot water. Herein, the heat exchanger may receive high-temperature heating water, which is branched from a branch of the heating pipe connected to the outflow unit of the heating device, at one side of the heat exchanger, followed by exchanging heat between the high-temperature heating water and the hot water. On the other hand, the heat exchanger may discharge low-temperature heating water to join the same into another branch of the heating pipe connected to the inflow unit of the heating device at the other side of the heat exchanger.

### Effect of Invention

The heating device according to the present invention includes an upper guide and a lower guide to guide movement of the fluid and form turbulence so as to control a speed of the fluid and heat transfer amount by the same, thereby eliminating a need to separately store the heating water and/or hot water to heat the fluid. Further, the fluid can be directly supplied from the tap water supply and then rapidly fed to any place where heating and/or hot water supply is needed.

### BRIEF DESCRIPTION OF DRAWINGS

FIG. 1 is a perspective view illustrating the in-pipe fluid heating device according to an embodiment of the present invention.

FIG. 2 is another perspective view illustrating the in-pipe fluid heating device according to an embodiment of the present invention.

FIG. 3 is a side view illustrating the in-pipe fluid heating device according to an embodiment of the present invention.

FIG. 4 is a front view showing the in-pipe fluid heating device according to an embodiment of the present invention.

FIG. 5 illustrates a flow pattern formed between adjacent upper and lower guides of the present invention.

FIG. 6 is a front sectional view illustrating an inflow unit and an outflow unit of the flat pipe for heat exchange of in-pipe fluid according to an embodiment of the present invention.

FIG. 7 is a front sectional view showing an inflow unit and an outflow unit of the flat pipe for heat exchange of in-pipe fluid according to other embodiments of the present invention.

FIG. 8 is a perspective view illustrating a case and a heat insulating material according to the present invention.

FIG. 9 is a schematic view illustrating a heating and hot water supply apparatus according to the present invention.

### BEST MODE

The present invention will become apparent with reference to the embodiments described below in detail together with the accompanying drawings. However, the present invention is not limited to the embodiments disclosed below and may be implemented in different forms. The present embodiments are only given to complete the disclosure of the present invention and to fully inform the scope of the invention to a person having ordinary knowledge in the technical field to which the present invention pertains. Therefore, the invention is only defined by the scope of the appended claims. Meanwhile, the terms used in the present specification are for explaining the embodiments and are not intended to limit the present invention. In this specification, the singular form also includes the plural form unless specified otherwise. As used herein, “comprises” and/or “comprising” refers to the components, steps, operations and/or elements mentioned above but do not exclude the presence or addition of one or more other components, steps, operations and/or elements. Terms such as “first” and “second” may be used to describe various components, but the components should not be limited by these terms. The terms are used only to distinguish one component from other components.

Hereinafter, embodiments of the present invention will be described in detail with reference to the accompanying drawings.

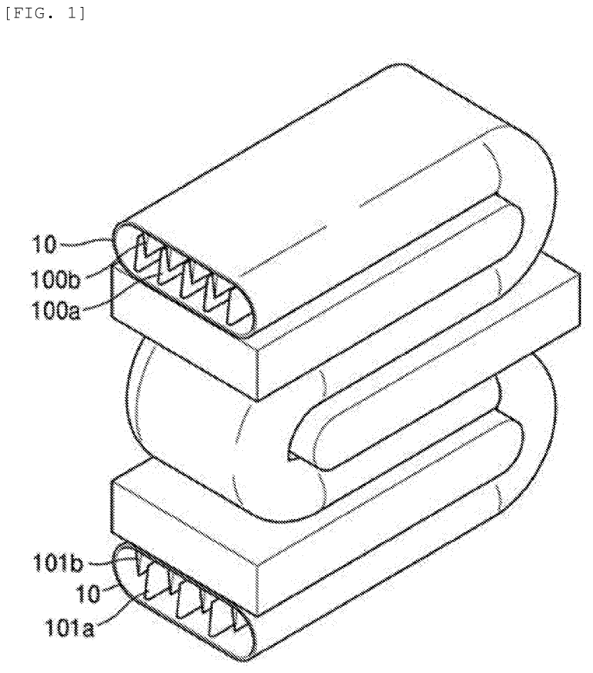

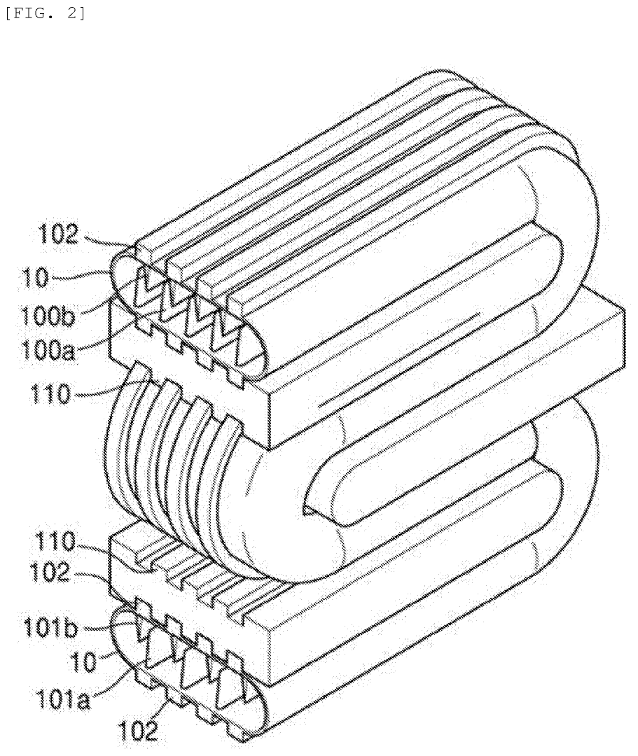

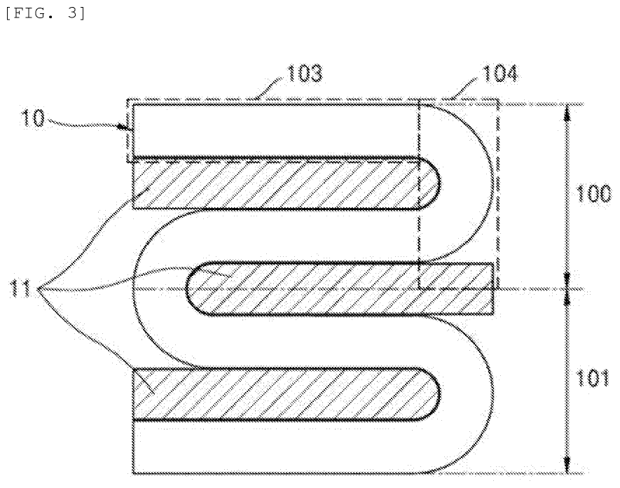

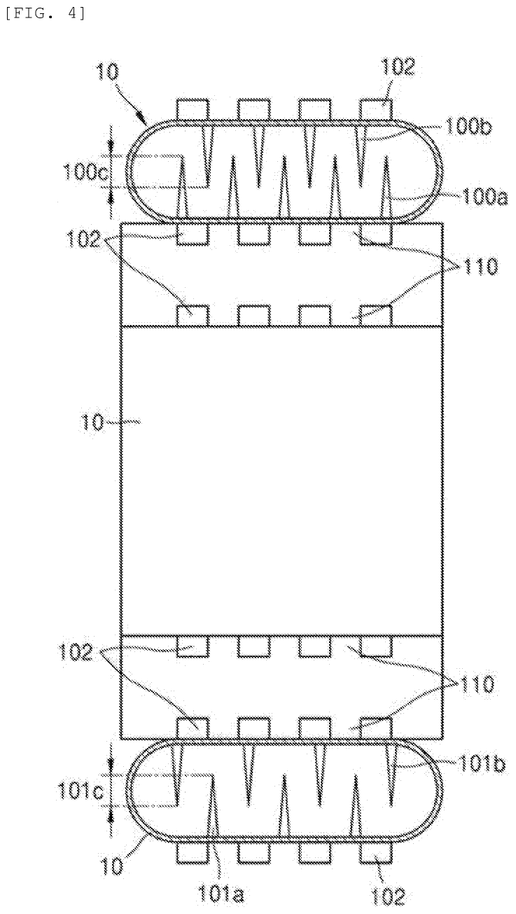

FIG. 1 is a perspective view illustrating the in-pipe fluid heating device according to an embodiment of the present invention. FIG. 2 is another perspective view illustrating the in-pipe fluid heating device according to an embodiment of the present invention. FIG. 3 is a side view illustrating the in-pipe fluid heating device according to an embodiment of the present invention. FIG. 4 is a front view showing the in-pipe fluid heating device according to an embodiment of the present invention.

Referring to FIGS. 1 to 4, the in-pipe fluid heating device 1 may be an apparatus to heat a fluid flowing in a pipe or conduit and utilize the same as a heating medium. The in-pipe fluid heating device 1 may include a flat pipe 10 for heat exchange of in-pipe fluid, a heating element 11 and a case 12.

The flat pipe for heat exchange of in-pipe fluid 10 (“flat pipe”) is provided for efficiently exchanging heat while the fluid flows through the pipe. The flat pipe may have a cross section with a width direction size (x direction) larger than a height direction size (y direction) thereof, may extend in a longitudinal direction (z direction), and may be designed in a shape formed by alternating a plurality of flat parts 103 and a plurality of curved parts 104.

The flat pipe 10 may include a flat part 103, a curved part 104, and upper guides 100b and 101b and lower guides 100a and 101a which are formed inside the pipe.

The flat part 103 of the flat pipe 10 may be a portion extending in parallel in the longitudinal direction (z direction).The curved part 104 of the flat pipe 10 may be a portion that is bent and connects a plurality of flat parts 103 disposed in the height direction (y direction).

The upper guides 100b and 101b may be a portion that guides the fluid flowing inside the flat pipe 10 and widens a heat transfer area of the flat pipe 10 whereby heat is well transferred from the heating element 11 to the fluid. The upper guides 100b and 101b may be provided in plural, and may be formed to protrude downward from the inner upper surface of the flat pipe 10.

The lower guides 100a and 101a may be portions that guide the fluid flowing inside the flat pipe 10 and widen the heat transfer area of the flat pipe 10 whereby heat is well transferred from the heating element 11 to the fluid. The lower guides 100a and 101a may be provided in plural, and may be formed to protrude upward from the inner lower surface of the flat pipe 10.

The upper guides 100b and 101b and the lower guides 100a and 101a may be formed to extend in the longitudinal direction (z direction). The upper guides 100b and 101b and the lower guides 100a and 101a, respectively, may be formed in a pin shape with narrowed width toward the end thereof. A plurality of the upper guides 100b and 101b and a plurality of the lower guides 100a and 101a may be alternately installed in the width direction (x direction) of the flat pipe 10. Therefore, the upper guides and the lower guides are provided in the flat pipe 10, as described above, and may have effects of: 1) widening a heat transfer area; and 2) forming turbulent flow in the width direction (x direction), which in turn induces 100% turbulent flow throughout a cross section of the flat pipe 10, whereby heat transfer to the fluid can be effectively attained.

Herein, convective heat transfer may be represented by Equation 1 below.

q=h*A*ΔT [Equation 1]

wherein, q is an amount of heat transfer, A is a cross-sectional area, and ΔT is a temperature difference. The convective heat transfer coefficient h is a coefficient indicating the amount of heat transfer from a solid surface to a fluid by convection, and is usually measured in Btu/hr·ft²·° F. This coefficient depends on physical states and properties of the fluid, a heat transfer surface and a structure. Therefore, a contact area and a velocity of the fluid affect the coefficient. In addition, as the turbulent flow becomes stronger, the fluid flowing close to the inner wall of the pipe and the fluid flowing in the center of the pipe may be uniformly mixed, whereby heat can be transferred throughout the entire flow rate to increase the heat transfer amount and the temperature of the entire fluid may become uniform.

The upper guides 100b and 101b and the lower guides 100a and 101a may be provided on the curved part 104 as well as the flat part 103 of the flat pipe 10. As a result, it is possible to reduce flow loss by guiding the fluid flowing even in the curved part 104 and reducing occurrence of local vortex (or eddy flow).

The flat pipe 10 may be divided into an inflow unit 100 for inflow of the fluid and an outflow unit 101 for outflow of the fluid in the longitudinal direction (z direction). Specifically, the inflow unit 100 may be a section of the flat pipe 10 that extends from an inlet (not shown) as an entrance through which the fluid flows into the flat pipe for heat exchange 10. On the other hand, the outflow unit 101 may be a section of the flat pipe 10 that extends from an outlet (not shown) as an exit through which the fluid flows out of the flat pipe 10 for heat exchange. The inflow unit 100 and the outflow unit 101 may be formed of a combination of a plurality of flat parts 103 and curved parts 104.

The number of the lower guides 100a and upper guides 100b mounted on the inflow unit 100 may be greater than the number of the lower guides 101a and upper guides 101b mounted on the outflow unit 101. For example, the inflow unit 100 may be provided with nine (9) guides including five (5) lower guides 100a and four (4) upper guides 100b, while the outflow unit 101 may be provided with three (3) lower guides 101a, which is fewer than the five (5) lower guides 100a in the inflow unit 100. Meanwhile, the outflow unit 101 may also include four (4) upper guides 101b, which is the same as in the inflow unit 100. Briefly, as described above, the total number of the lower guides 100a and the upper guides 100b mounted on the inflow unit 100 may be nine (9) whereas the total number of the lower guides 101a and the upper guides 101b mounted on the outflow unit 101 may be seven (7), which is eventually fewer than that in the inflow unit 100. The fluid is heated by the heating element 11 while flowing from the inflow unit 100 to the outflow unit 101, thus elevating a temperature. If the same amount of heat is maintained throughout the inflow unit and the outflow unit of the flat pipe 10, the temperature of the fluid is too high, causing a problem in that the fluid boils or generates bubbles, thereby generating noise. Therefore, by decreasing the number of the upper guides 101b and the lower guides 101a in the outflow unit 101 as compared to the number of the upper guides 100b and the lower guides 100a in the inflow unit 100, heat transfer performance may be reduced, thereby solving the above-described problem.

At least one of the upper guide 100b or 101b and the lower guide 100a or 101a may have an overlapping portion 100c or 101c, which overlaps with the adjacent lower guide 100a or 101a or the adjacent upper guide 100b or 101b in a height direction (y direction) of the flat pipe 10.

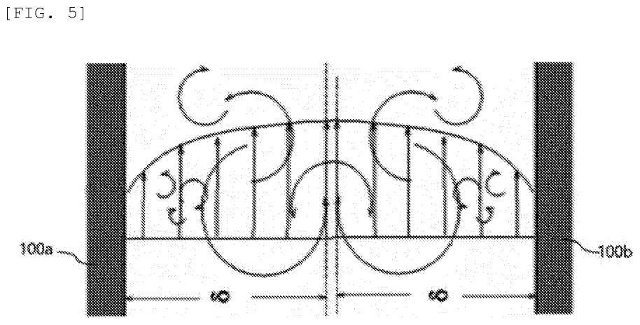

FIG. 5 illustrates a flow pattern formed between adjacent upper and lower guides of the present invention.

Referring to FIG. 5, at least one of the lower guide 100a or 101a and the upper guide 100b or 101b may have an overlapping portion 100c or 101c, which is formed in a range of 25% or more and 87.5% or less of the height direction size (y direction) of the flat pipe 10, thereby maximizing turbulence efficiency. Owing to formation of the overlapping portion 100c or 101c, turbulent flow may increase to promote heat transfer by convection. Turbulent flow may occur between the overlapping portions 100c and 101c of the adjacent upper guides 100b and 101b and the adjacent lower guides 100a and 101a, respectively, and, due to such turbulent flow, the fluid is mixed and heat may be uniformly transferred throughout the fluid.

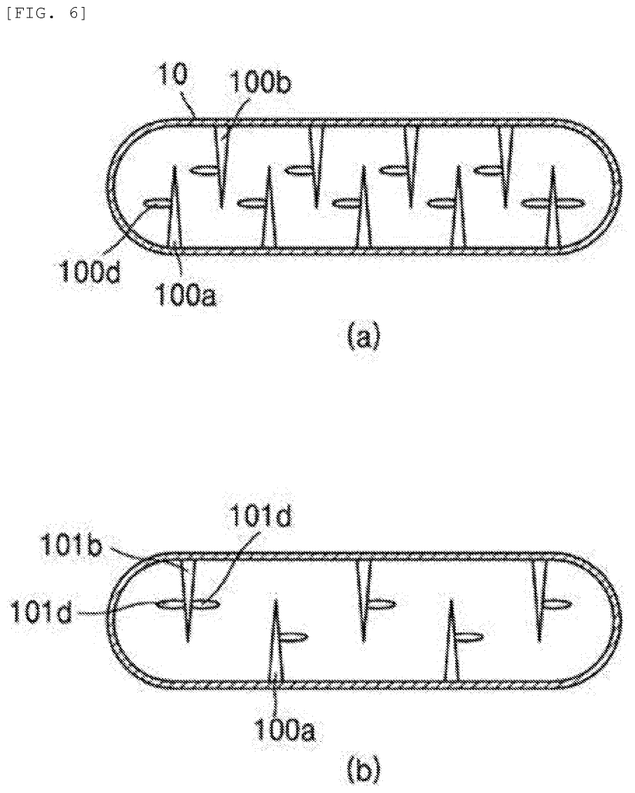

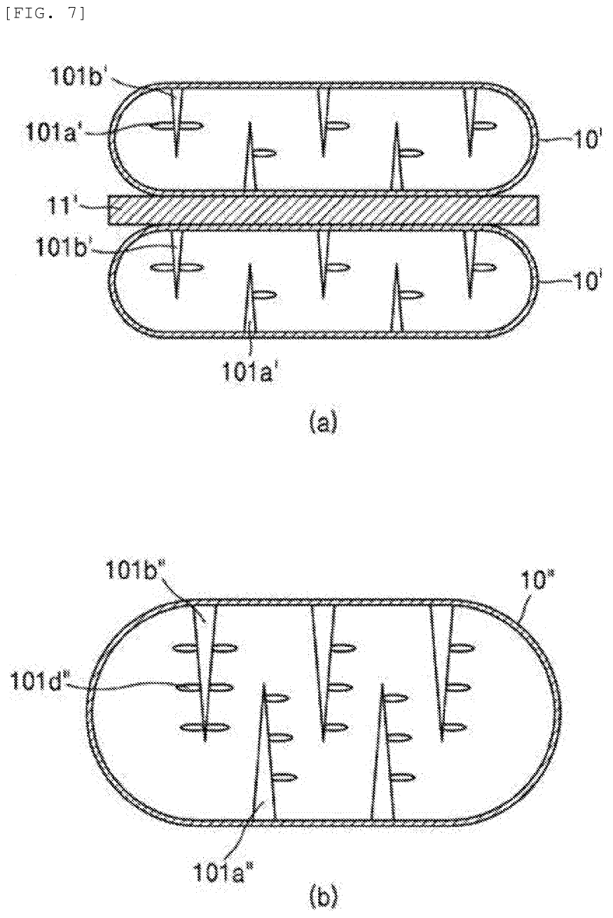

FIG. 6 is a front sectional view illustrating an inflow unit and an outflow unit of the flat pipe for heat exchange of in-pipe fluid according to an embodiment of the present invention. FIG. 7 is a front sectional view showing an inflow unit and an outflow unit of the flat pipe for heat exchange of in-pipe fluid according to other embodiments of the present invention.

Referring to FIGS. 6 and 7, at least one of the lower guide 100a and the upper guide 100b may be provided with alternative width direction guides 100d and 101d (“width guide”) which are formed to protrude in the width direction (x direction) of the flat pipe 10. Such a width guide 100d or 101d may induce turbulence of the fluid. The width guide 100d or 101d may protrude from one among both sides of the upper guide 100b or 101b and the lower guide 100a or 101a. However, among the upper guides 100b and 101b and the lower guides 100a and 101a, one thereof disposed on the outermost side in the width direction (x direction) may be formed to protrude from both sides. As a result, turbulent flow may be induced throughout the width of the flat pipe 10.

For example, in the case of the inflow unit 100, a width guide 100d may protrude from the left surfaces of the upper guide 100b and the lower guide 100a, respectively, while the width guide 100d may also protrude from both surfaces of the lower guide 100a disposed at the rightmost side (see FIG. 6(a)). Further, in the case of the outflow unit 101, a width guide 101d may protrude from the right surfaces of the upper guide 101b and the lower guide 101a, respectively, while the width guide 101d may also protrude from both surfaces of the upper guide 101b disposed at the leftmost side (see FIG. 6(b)). Therefore, turbulence may occur throughout the width direction (x direction) of the flat pipe 100, thereby promoting heat transfer in the fluid.

In addition, when the in-pipe fluid heating device 1 of the present invention is used for industrial purposes rather than for domestic use, the fluid for heating and hot water supply may require high flow rate. In order to increase the flow rate of the fluid, a plurality of flat pipes 10′ is laminated and coupled in the height direction (y direction) to thus produce a flat pipe assembly capable of accommodating substantially the same amount of fluid as that received in two (2) flat pipes 10′. As such, the plurality of flat pipes 10′ may be laminated and a heating element 11′ may be disposed therebetween so as to efficiently heat the in-pipe fluid (see FIG. 7(a))

Further, increasing the height direction (y direction) value of the flat pipe 10″ may increase the cross-sectional area of the flat pipe 10″, thereby accommodating a large amount of fluid, that is, the fluid at a higher flow rate. At this time, in order to efficiently heat the in-pipe fluid, a plurality of width guides 100d″ may protrude from the upper guide 100b″ and the lower guide 100a″(see FIG. 7(b)).

The heating element 11 may be disposed between the flat parts 103 of the flat pipe 10 to heat the fluid flowing inside the flat pipe 10. The heating element 11 may be formed of a PTC device, which has excellent heating performance and is easily molded. The PCT device is typically molded into a plate shape and may be disposed between the flat parts 103 of the flat pipe 10. Herein, PTC device is a generic term for an electric heating element using a PCT thermistor. For example, when applying electricity to a resistor, which exhibits a rapid increase in resistance at a predetermined temperature or higher, such as a barium titanate-based (BaTiO₃-based) semiconductor, to heat the same, the resistance of the resistor increases to suppress current, whereby the temperature may remain almost constant regardless of change in external air temperature or power supply voltage. The PCT device is substantially a self-controlled heater having a combination of three functions of a heating element, a temperature sensor and a power controller without a problem of overheating.

On the outer upper and lower surfaces of the flat pipe 10, uneven parts 102 may be aligned in the width direction (x direction) of the flat pipe 10 and may also be formed to extend in the longitudinal direction (z direction) of the flat pipe 10. Further, uneven parts 110 may be provided on upper and lower surfaces of the heating element 11 and may be formed in a shape complementary to the above uneven parts 102 of the flat pipe 10. In addition, alternative uneven parts 110 may also be provided on a side where the heating element 11 is in contact with the curved part 104 and may be formed in a shape complementary to the uneven parts 102 of the flat pipe 10. Therefore, the uneven part 102 of the flat pipe 10 and the uneven part 110 of the heating element 11 are engaged with each other to be fastened, thereby increasing fastening force and widening a contact area between the flat pipe 10 and the heating element 11 to enhance heat transfer performance.

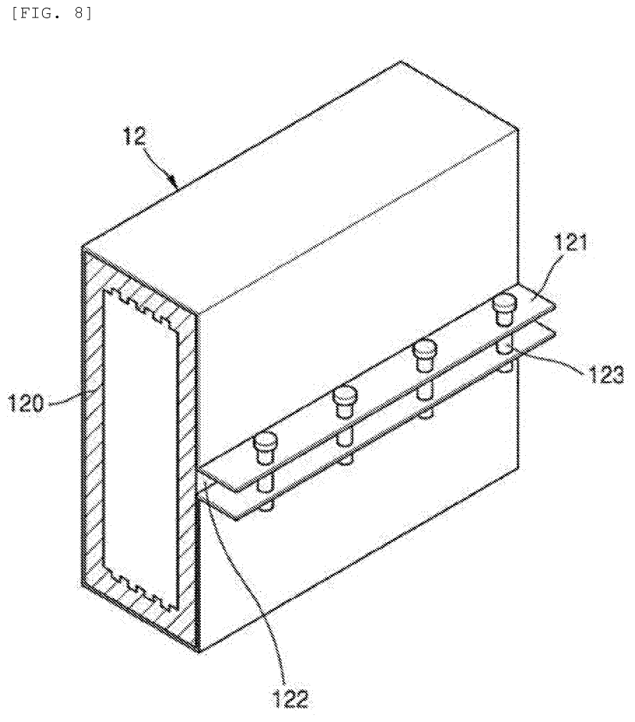

FIG. 8 is a perspective view illustrating a case and a heat insulating material according to the present invention.

Referring to FIG. 8, the case 12 may serve to insulate the assembly of the flat pipe 10 and the heating element 11 from the outside. The case 12 may include a slit 122, fixing members 121 and a connector 123.

The slit 122 may be open on the case 12 and extend in the longitudinal direction of the flat pipe 10. The fixing members 121 may protrude from both sides of the width of the slit, respectively, and face each other. Each fixing member 121 may include a plurality of fixing holes formed therein, through which the connector 123 can be inserted. The connector 123 is inserted into the fixed holes to connect the fixing members 121 to each other, and may apply contractile force to reduce a spacing therebetween. The connector 123 may consist of a bolt and a nut and, as the bolt is inserted into the fixing hole and fixed with the nut, contractile force may be applied to the fixing member 121, thereby generating shrinkage force to contract the case 12 in the height direction (y direction). Further, the flat pipe 10 and the heating element 11 disposed between the flat pipe may be pressed up and down to maintain surface contact with each other. As a result, an amount of heat transferred from the heating element 11 to the inside of the flat pipe 10 may be increased.

Between the case 12 and the flat pipe 10, a heat insulating material 120 may be interposed in order to prevent heat emitted by the heating element 11 from being transferred to the outside. The heat insulating material 120 may be prepared using a raw material such as expanded polystyrene, expanded polyethylene or expanded polypropylene. An inner surface of the heat insulating material 120 may be formed in a shape complementary to an external appearance of the in-pipe fluid heating device 1, and may be mounted to be close to the same. More particularly, upper and lower sides of the inner surface of the heat insulating material 120 may be formed in a shape complementary to the shape of the uneven part 102 in the flat pipe 10.

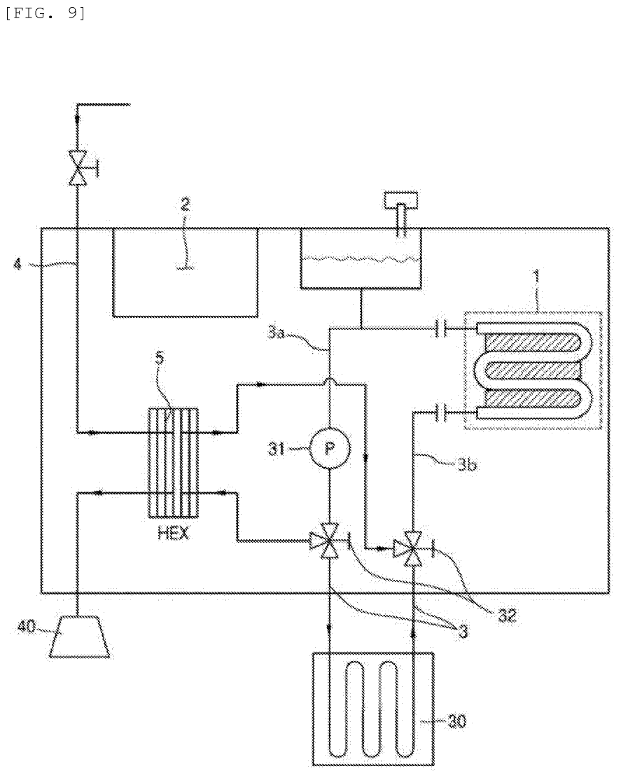

FIG. 9 is a schematic view illustrating a heating and hot water supply apparatus according to the present invention.

Hereinafter, a heating and hot water supply apparatus including the in-pipe fluid heating device 1 will be described.

The heating and hot water supply apparatus may be an apparatus that conducts heating in a space requiring heating, as well as hot water supply. The heating and hot water supply apparatus may include an in-pipe fluid heating device (“heating device”), a heating pipe 3, a heating unit 30, a pump 31, a hot water pipe 4, a heat exchanger 5, a controller 2 and a valve.

The heating pipe 3 may be a pipe through which the heating water, that is, the fluid heated in the in-pipe fluid heating device 1 circulates. The heating pipe 3 may include a recovery pipe 3b in which the heating water circulated in the heating unit 30 and then heated to a low temperature flows into the inflow unit 100 of the in-pipe fluid heating device 1, followed by being returned. The heating pipe 3 may include a feed pipe 3a that supplies the heating water at a high temperature flowing out of the outflow unit 101 of the in-pipe fluid heating device 1 in the pipe to the heating unit 30.

The heating unit 30 is connected to the heating pipe 3 and may be disposed in a space to be heated so as to heat the same. The heating unit 30 may consist of a floor heating pipe, a wall heating pipe, a ceiling heating pipe, and/or a radiator, which are installed on the floor, wall, and/or ceiling of the building.

The pump 31 may be connected to the heating pipe 3 to allow the heating water to circulate in the heating pipe 3 through the in-pipe fluid heating device 1 and the heating unit 30. Preferably, the pump 31 is connected to the feed pipe 3a to apply power used to supply the high-temperature hot water that flows out of the in-pipe fluid heating device 1 to the heating unit 30.

The hot water supply pipe 4 may receive water from a tap water supply and deliver it to the user. The hot water supply pipe 4 may be connected to the tap water supply and a domestic water faucet 40.

The heat exchanger 5 is connected to the hot water supply pipe 4 and the hot water, which is tap water in the hot water supply pipe 4, may be exchanged with the heating water in the heating pipe 3 to increase the temperature of the hot water. The heat exchanger 5 receives the high-temperature heating water branched from a branch of the heating pipe 3 connected to the outflow unit 101 of the in-pipe fluid heating device 1 at one side of the heat exchanger, thereby exchanging heat between the heating water and the hot water. On the other hand, the heat exchanger discharges the low-temperature heating water to join the same into another branch of the heating pipe 3 connected to the inflow unit 100 of the in-pipe fluid heating device 1 at the other side of the heat exchanger. That is, the heat exchanger 5 may receive the high-temperature heating water from the feed pipe 3a so as to exchange heat between the hot water and the heating water, while discharging the low-temperature heating water to be recovered through a recovery pipe 3b.

The controller 2 may regulate the valve 32 to control heating and hot water supply. For example, the high-temperature heating water may be fed to the heating unit 30 and/or the heat exchanger 5 by regulating the valve 32 connected to the feed pipe 3a. Further, the low-temperature heating water may be fed from the heating unit 30 and/or the heat exchanger 5 and then recovered in the inflow unit 100 of the in-pipe fluid heating device by regulating the valve 32 connected to the recovery pipe 3b.

The in-pipe fluid heating device 1 according to the present invention may use a PTC element as the heating element 11 to maintain the temperature of the fluid at 100° C. or less, and may supply the heating water at a temperature suitable for heating and hot water supply.

Since the in-pipe fluid heating device 1 includes the upper guides 100b and 101b and the lower guides 100a and 101a, movement of the fluid is guided and turbulence is formed so as to control a fluid rate and a heat transfer amount of the fluid, thereby eliminating a need to store the heating water and/or hot water separately. Further, it is possible to increase heat transfer efficiency and prevent noise by suppressing air bubbles or cavitation. In addition, the fluid may be directly received from a tap water supply and then rapidly supplied to any place where heating and/or hot water is required.

Further, the in-pipe fluid heating device 1 may include different numbers of upper guides 100b and 101b and lower guides 100a and 101a installed in the inflow unit 100 and the outflow unit 101, respectively, so as to prevent a temperature of fluid from undesirably increasing. Further, the fluid temperature may be maintained at 100° C. or less to suppress generation of air bubbles or cavitation, thereby preventing noise. In addition, it is possible to supply heating water at an appropriate temperature for heating and hot water supply.

The above description is merely illustrative of the technical idea of the present invention, and those skilled in the art to which the present invention pertains may implement various modifications and variations without departing from the essential characteristics of the present invention. Therefore, the embodiments disclosed in the present invention are not intended to limit the technical spirit of the present invention but to specify the same, and the scope of the technical spirit of the present invention is not limited by these embodiments. Instead, the scope of protection of the present invention should be interpreted by the appended claims below, and all technical spirits within the equivalent range should be construed as being included in the scope of the present invention.

1. A flat pipe for heat exchange of a fluid in a pipe (“in-pipe fluid”), which has a cross section with a width direction size larger than a height direction size, extends in a longitudinal direction and includes a plurality of flat parts and curved parts formed alternately, comprising:
a plurality of lower guides protruding from an inner lower surface of the flat pipe toward an upper side thereof, and a plurality of upper guides protruding from an inner upper surface of the flat pipe toward a lower side thereof, which are alternately provided in the width direction of the flat pipe; and
an overlapping portion present in either the lower guide or the upper guide, at which the lower guide or the upper guide is overlapped with either of the adjacent upper guide or lower guide in the height direction of the flat pipe.

2. The flat pipe according to claim 1, wherein at least one of the lower guide and the upper guide has the overlapping portion formed in a range of 25% or more and 87.5% or less of a height direction size of the flat pipe.

3. The flat pipe according to claim 1, wherein at least one of the lower guide and the upper guide is provided with a width direction guide (“wide guide”) protruding in a width direction of the flat pipe.

4. The flat pipe according to claim 1, wherein the flat pipe is divided into an inflow unit for inflow of a fluid and an outflow unit for outflow of the fluid in a longitudinal direction, and a number of the lower guides and upper guides provided in the inflow unit is more than the number of the lower guides and upper guides provided in the outflow unit.

5. An in-pipe fluid heating device, comprising:
the flat pipe for heat exchange of in-pipe fluid according to any one of claims 1 to 4; and
a heating element disposed between the flat parts of the flat pipe in order to heat the fluid flowing inside the flat pipe.

6. The heating device according to claim 5, wherein an uneven part is formed on outer upper and lower surfaces of the flat pipe in the width direction of the flat pipe and extends in the longitudinal direction of the flat pipe,
another uneven part having a shape complementary to that of the above uneven part is formed on upper and lower surfaces of the heating element, and
an alternative uneven part having a shape complementary to the uneven part is formed on a side where the heating element is in contact with the curved part of the flat pipe.

7. The heating device according to claim 5, further comprising: a case that surrounds the flat pipe and the heating element and imparts elastic force to maintain contact between the flat pipe and the heating element.

8. The heating device according to claim 7, wherein the case includes:
a slit extending and opening in the longitudinal direction of the flat pipe on the case;
fixing members protruding from opposite sides of the width of the slit and facing each other; and
a connector that connects the fixing members to each other and applies contractile force to reduce a spacing therebetween.

9. The heating device according to claim 7, wherein a heat insulating material is filled between the case and the flat pipe in order to prevent transfer of heat generated by the heating element to the outside of the heat insulating material.

10. A heating and hot water supply apparatus, comprising:
the in-pipe fluid heating device according to claim 5 (“heating device”);
a heating pipe in which a fluid heated in the heating device, that is, heating water, circulates;
a heating unit connected to the heating pipe and installed in a space to be heated in order to heat the space;
a pump connected to the heating pipe to circulate the heating water in the heating pipe while passing through the heating device and the heating unit;
a hot water supply pipe that receives water from a tap water supply and delivers the same to a user; and
a heat exchanger connected to the hot water supply pipe to exchange heat between tap water in the hot water supply pipe, that is, the hot water to be supplied (“hot water”) and the heating water in the heating pipe to increase a temperature of the hot water,
wherein the heat exchanger receives high-temperature heating water, which is branched from a branch of the heating pipe connected to the outflow unit of the heating device, at one side of the heat exchanger, followed by exchanging heat between the high-temperature heating water and the hot water, while discharging low-temperature heating water to join the same into another branch of the heating pipe connected to the inflow unit of the heating device at another side of the heat exchanger.
